(19) United States
(12) Patent Application Publication
(10) Pub. No.: US 2011/0240897 A1
(43) Pub. Date: Oct. 6, 2011

(54) Pressure Limiting And Suction Valve Unit

(75) Inventors: Markus Gepraegs, Ulm (DE); Erik Wilhelm, Ulm (DE); Stefan Joksch, Ulm (DE)

(73) Assignee: Robert Bosch GmbH, Stuttgart (DE)

(21) Appl. No.: 13/122,473

(22) PCT Filed: Oct. 7, 2009
(86) PCT No.: PCT/EP2009/007189

§ 371 Date: Jun. 21, 2011

(30) Foreign Application Priority Data
Oct. 8, 2008 (DE) 102008050864.0

(51) Int. Cl. F16K 3/30

(52) U.S. Cl. 251/282

(57) ABSTRACT

A pressure limiting and suction valve unit includes a valve closing body including a valve closing face, which, together with a first valve seat lying opposite the valve closing face, forms a first sealing seat for sealing off a first pressure region from a second pressure region, a second valve seat defining a valve closing body orifice, the valve closing body orifice, together with a closing head formed on an axially movable valve pin, forms a second sealing seat for sealing off the second pressure region from the first pressure region, a spring plate connected to the valve pin and movable axially together with the valve pin, a first closing spring which is tension-mounted between the spring plate and the valve closing body and prestresses the valve pin against the second valve seat formed on the valve closing body, and a second closing spring which prestresses a valve subassembly against the first valve seat, wherein the valve pin is guided sealingly in at least one first guide portion formed in the valve closing body, wherein the second valve seat and the first guide portion are configured to be arranged on different sides of the second pressure region with respect to the direction of movement of the valve pin, wherein the first guide portion is configured to separate a volume connected to the first pressure region from one of the second pressure region and a volume connected to the second pressure region, and wherein a cross-sectional area of the first guide portion is configured to define a surface of a valve pin, said surface being acted upon by the pressure of the second pressure region, is smaller than a cross-sectional area of the second valve seat.

The invention relates to a pressure limiting and suction valve unit.

German Laid-open publication DE 10 2004 061 862 A1 discloses a pressure limiting and suction valve unit with a pressure limiting function according to the preamble of claim 1. The valve unit comprises a valve closing body having a valve closing face which, together with a first valve seat lying opposite the valve closing face, forms a first sealing seat for the feed function, and having a valve closing body orifice which is surrounded by a second valve seat and which, together with a closing head formed on an axially movable valve pin, forms a second sealing seat for the pressure limiting function. A spring plate, the valve closing body and the valve pin are in this case guided in various bore portions.

The disadvantage of known, directly controlled pressure limiting and suction valve units is not only the overall length and limited space for arranging the springs, but also that, in the case of greater volume flows, the cross sections and therefore also the pressure engagement surfaces become larger, with the result that the compression springs, too, are stronger.

It has therefore also already been proposed in German Laid-open publication DE 10 2004 061 862 A1 to achieve pressure equalization between a first pressure region and a blind bore, into which only the valve pin partially extends, by means of a longitudinal bore over the entire length of the valve pin. As a result, the force exerted in the opening direction upon the valve closing body is determined solely by a differential area arising from the blind bore cross section and the valve closing face. By virtue of small differential areas, low opening forces and therefore springs with low spring constants can be implemented.

The disadvantage of the known pressure limiting and suction valve unit, however, is that the guidance of the valve pin from the valve closing body orifice into the blind bore results in a very long valve pin and in an overdetermined system. This leads to short service lives of the pressure limiting and suction valve unit and, during operation, to high unpredictable frictional influences which may adversely alter the opening properties of the pressure limiting and suction valve unit. The long valve pin additionally leads to an, overall, very long pressure limiting and suction valve unit, for which large installation spaces which are costly or are sometimes not even present have to be provided. By contrast, the space provided for arranging the springs is relatively small.

The object on which the invention is based is to provide a pressure limiting and suction valve which is improved with respect to the prior art. In this case, in particular, easy adaptation of the opening cross section for the pressure limiting function and of the pressure-active area is to be implemented and the long-term functioning of the valve unit is to be ensured.

The object is achieved by means of the pressure limiting and suction valve unit according to the invention as claimed in claim 1.

The pressure limiting and suction valve unit according to the invention has a first sealing seat and a second sealing seat. The first and the second sealing seat in each case separate a first pressure region from a second pressure region. The first sealing seat is formed as a result of the cooperation of a valve closing body, on which a first valve closing face is formed, with a first valve seat. The second sealing seat is formed between the valve closing body and a valve pin. On the valve pin, which is axially movable, a closing head is formed, which, in order to form the second sealing seat, cooperates sealingly with a valve closing body orifice surrounding a second valve seat. In order to keep the second sealing seat closed, a first closing spring is provided which is arranged between the valve closing body and a spring plate. For this purpose, the spring plate is connected to the valve pin. In order to keep the first sealing seat closed, a second closing spring is provided which prestresses a valve subassembly against the first valve seat. The valve subassembly in this case comprises the valve pin, the valve closing body and the components, to be precise the first closing spring and spring plate, which are necessary for prestressing the valve pin against the valve closing body.

According to the invention, then, the valve pin is guided in the valve closing body. For this purpose, in the valve closing body, at least one first guide portion is formed in which the valve pin is sealingly guided in a longitudinally displaceable manner. Sealing in this case takes place preferably by means of an appropriately narrow tolerance of the diameters of the valve pin and of the guide portion. This first guide portion is formed, with respect to the direction of movement of the valve pin, on that side of the valve closing body which faces away from the second sealing seat. By means of the first guide portion, a volume connected to the first pressure region is separated from the second pressure region or from a volume connected to the second pressure region. Furthermore, a cross-sectional area of the first guide portion is smaller than a cross-sectional area of the second valve seat. Consequently, by the difference in cross-sectional areas being set, the size of a valve pin surface acted upon by the pressure of the second pressure region can be set. By virtue of this procedure for setting the valve pin surface acted upon by the pressure of the second pressure region, adaptation to the spring force which is required for closing counter to the pressure of the second pressure region can be carried out in a simple way. In particular, with a specific spring being maintained, adaptation of the hydraulic opening force, for example after a change in an outflow cross section of the second sealing seat, can be carried out by adapting the cross-sectional area in the first guide portion.

The sub-claims relate to advantageous developments of the pressure limiting and suction valve unit according to the invention.

In particular, it is advantageous to form in the valve closing body a volume which is connected to the first pressure region or to the second pressure region and is arranged such that a radial step formed on the valve pin is arranged within the axial extent of the volume and is acted upon by the pressure prevailing there. As a result of such a step being formed, the pressure-active area can be set, in particular, independently of the diameter of the second valve seat. On the other hand, a change in the diameter of the valve seat can be compensated by a corresponding adaptation of the radial step. Thus, in each case, an active area capable of being acted upon by the pressure in the second pressure region and located on the valve pin can be produced, which matches with a specific selected closing spring. A renewed adjustment by the selection of suitable closing springs after the outflow cross section at the second sealing seat has been adapted may therefore be dispensed with.

If the volume within the valve closing body is connected to the first pressure region, it is especially preferable to arrange a duct for connecting the first pressure region to the volume, within the valve pin.

If, however, the second pressure region is to be connected to the volume, the connecting duct is preferably routed in the valve closing body. Both solutions have the advantage that the ducts can be provided by making simple bores which are introduced before the parts are assembled. In this case, in particular, it is advantageous that the duct cross sections are relatively insensitive to manufacturing tolerances.

On that side of the valve closing body which faces away from the closing head, a spring space is preferably formed in which the first and the second closing spring are arranged. This spring space is preferably connected to the other pressure region in each case. The first guide portion thus preferably separates a volume formed within the valve closing body from a volume of the spring space, one of the two regions being connected to the first pressure region and in each case the other volume being connected to the second pressure region.

Especially preferably, that portion of the valve pin which has the smaller diameter and is guided in the first guide portion projects into the spring space. That end of the valve pin which faces away from the closing head therefore points into the spring space. When a radial step is provided on the valve pin and is arranged in the volume in the closing body, it is especially preferable if the valve pin is guided in a first guide portion and in a second guide portion in the axial direction on both sides of this radial step respectively. The second guide portion is in this case arranged between the first guide portion and the closing head of the valve pin. This is advantageous especially when the second guide portion and the second valve seat also have the same diameter. In this case, for example, adaptation of the opening cross section can be carried out in a simple way when the closing head is lifted off from the second valve seat. Both the diameter of the second guide portion and the diameter of the second valve seat are changed in the same way. On the other hand, since the pressure-active area to be acted upon with the high pressure is defined by the reduction in diameter of the first guide portion, when the pressure of the second pressure region acts upon the valve pin in the spring space the opening behavior of the pressure limiting and suction valve unit is not altered and unchanged closing springs can be used.

So that that end face of the valve pin which faces away from the closing body can be acted upon with the pressure of the second pressure region, it is especially advantageous if the valve closing body is guided with a clearance fit in a reception recess which at the same time forms the spring space. The spring space is thus connected to the second pressure region via the clearance fit between the valve closing body and the housing part or else via an additionally formed connecting duct. A clearance fit means in this context that an outside diameter of the valve closing body is always designed to be slightly smaller than the diameter of a bore receiving the valve closing body.

Further simplification in terms of manufacture arises when the diameter of the first sealing seat and the guidance diameter of the valve closing body are of equal size. The number of drilling tools required is thus reduced.

The invention is described in more detail below by means of a preferred exemplary embodiment, with reference to the drawing in which:

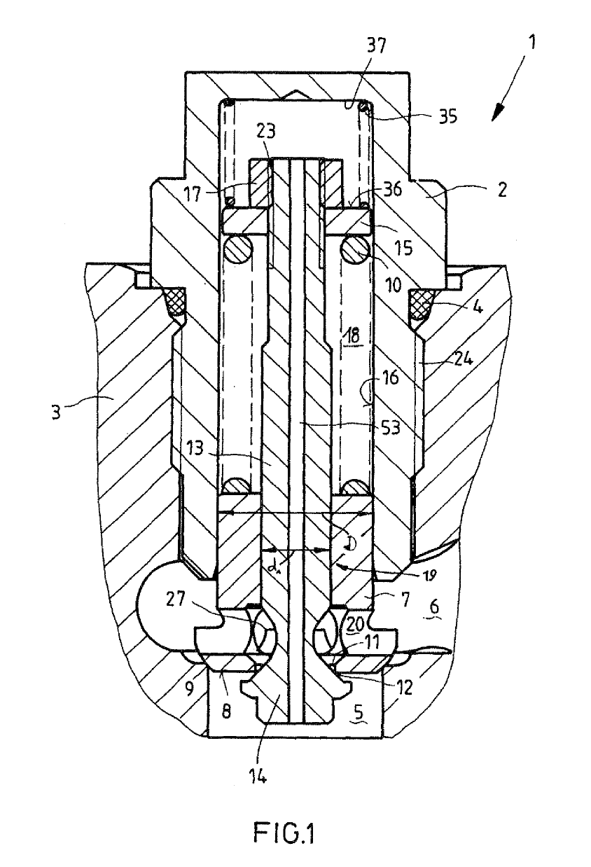

FIG. 1 shows a sectional illustration of a first exemplary embodiment of a pressure limiting and suction valve unit according to the invention;

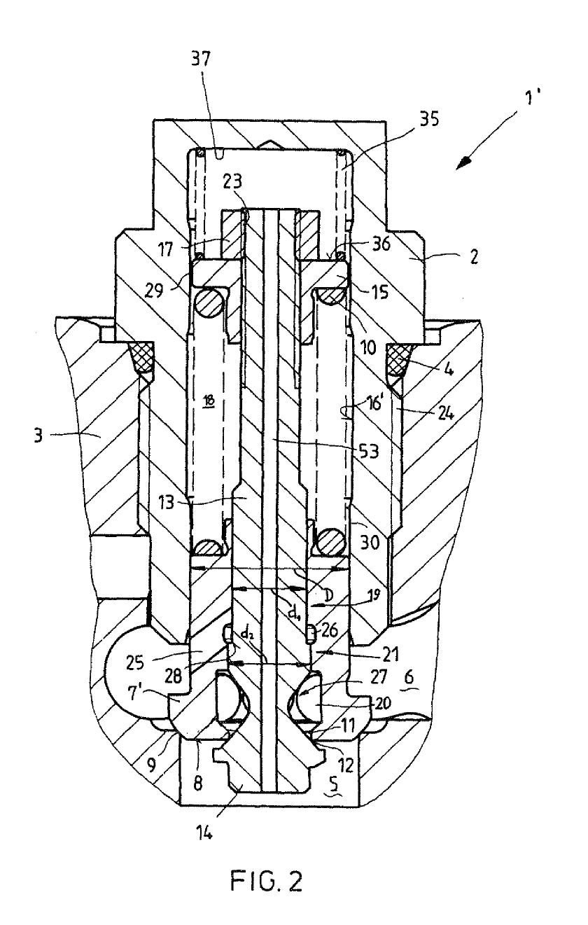

FIG. 2 shows a sectional illustration of a second exemplary embodiment of a pressure limiting and suction valve unit according to the invention with a radial step on the valve pin; and

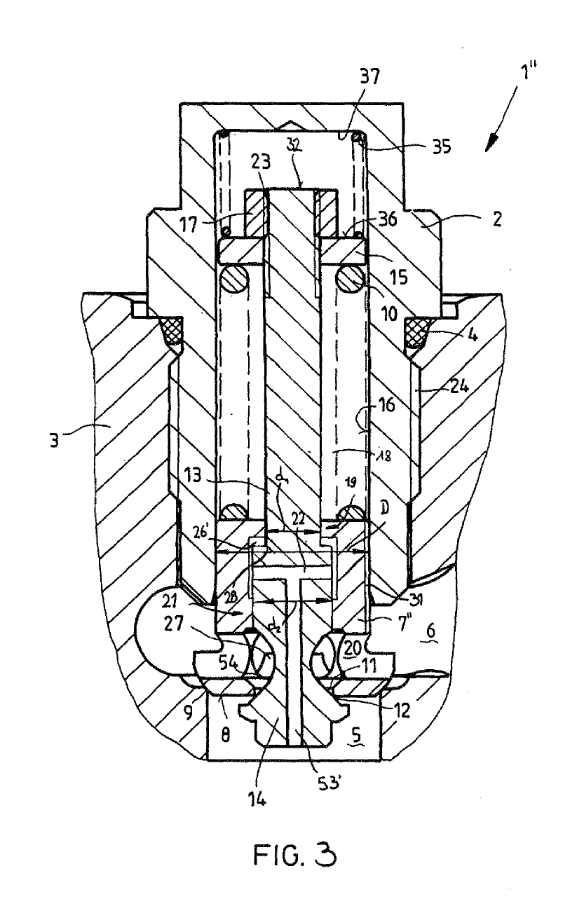

FIG. 3 shows a third exemplary embodiment with a spring space connected to the second pressure region and with a radial step on the valve pin.

FIG. 1 shows an exemplary embodiment of the pressure limiting and suction valve unit 1 according to the invention. Before the construction and function of the pressure limiting and suction valve unit 1 are described with reference to FIG. 1, an example of the use of the pressure limiting and suction valve unit 1 according to the invention will be described in order to illustrate its functioning.

An important use of pressure limiting and suction valve units 1 is, for example, in closed hydraulic circuits. Since hydrostatic machines always lose some fluid due to leakage, the fluid quantity has to be made up by feeding in hydraulic fluid, in order thereby to keep the pressure medium quantity constant in the working lines which connect the hydraulic motor and pump. Suction valves therefore have to feed required quantities of pressure medium into a working line from a feed system in which a low pressure of, for example, approximately 25 bar prevails, if a pressure drop in the working line occurs below a limit, to be set or structurally fixed, for an opening pressure of the suction valve of the pressure limiting and suction valve unit in the first direction of the pressure gradient. A pressure medium source, mostly in the form of a feed pump, is provided for feeding in pressure medium.

In the closed circuit, there are two working lines between, for example, a hydraulic motor and hydraulic pump, during operation one of the working lines usually carrying high pressure and the other working line low pressure. On the low-pressure side, for the conveyance of leakage fluid pressure medium is fed via a pressure limiting and suction valve unit 1 from a feed line of the feed system to the working line, if the pressure in this working line falls below a fixed value. By contrast, in the working line of the respective high-pressure side, the prevailing high pressure is limited for safety reasons by a pressure limiting valve, opening in the case of maximum pressure, of the pressure limiting and suction valve unit 1.

The hydraulic circuit described serves merely for explaining the functioning in a simple way. Other possibilities of use may, of course, likewise be envisaged.

The pressure limiting and suction valve unit 1 has a first valve housing part 2 which is screwed into a thread 24 of a second valve housing part 3, illustrated merely diagrammatically, and which is sealed off by means of a sealing ring 4. In the second valve housing part 3 are formed a feed connection 5, for example of the feed system described above, as a first pressure region and a working line connection 6 as a second pressure region for connection to a working line, which connections can be connected to one another by means of the pressure limiting and suction valve unit 1.

At its end facing the feed connection 5, which is connected to the feed system, not shown, in the example described above, the pressure limiting and suction valve unit 1 has a valve closing body 7, on which is formed a valve closing face 8 having an approximately frustoconical design in the exemplary embodiment. The valve closing face 8 cooperates with a first valve seat 9 lying opposite the valve closing face 8, in order to form a first sealing seat. The first valve seat 9 is formed in the second valve housing part 3.

Furthermore, the valve closing body 7 has a valve closing body orifice 11 which is surrounded on its circumference by a second valve seat 12. The second valve seat 12 cooperates with a closing head 14 provided on a valve pin 13, so as to form a second sealing seat. In the exemplary embodiment, the valve pin 13 extends through the valve closing body orifice 11. At its end which faces away from the closing head 14 and projects out of the valve closing body 7, the valve pin 13 is connected to a spring plate 15. A first closing spring 10 extends between the spring plate 15 and the valve closing body 7 such that the first closing spring 10 is tension-mounted between the spring plate 15 and the valve closing body 7. The closing head 14 of the valve pin 13 is thereby held in sealing bearing contact against the second valve seat 12 surrounding the valve closing body orifice 11. The valve pin 13, the first closing spring 10, the spring plate 15 and that part of the valve closing body 7 which faces away from the valve closing head 13 are received into the first valve housing part 2 by an axial bore as a reception recess 16.

The spring plate 15 is secured on the valve pin 13 by a securing body 17, for example a lock nut. An axial longitudinal bore 53 is formed in the valve pin 13. The valve pin 13 is provided at the end facing away from the closing head 14 with an external thread 23 which cooperates with a corresponding internal thread of the spring plate 15 and of the securing body 17 which locks the spring plate 15. The axial position of the spring plate 15 with respect to the valve pin 13 can therefore be varied by the valve pin 13 being rotated with respect to the spring plate 15, with the result that the prestress of the first closing spring 10 can be set.

A second closing spring 35 is arranged between that end face 36 of the spring plate 15 which faces away from the closing head 14 and the end face 37 of the axial bore of the housing 2 as a reception recess 16, in order to exert a closing force upon a valve subassembly composed of the valve closing body 7, of the valve pin 13, of the spring plate 15, of the lock nut 17 and of the first closing spring 10. The valve subassembly 7, 13, 15, 17, 10 is in this case guided axially movably in the axial bore of the first housing part 2. The tension-mounted, relatively weak second closing spring 35 thus prestresses the valve subassembly 7, 13, 15, 17, 10 against the first valve seat 9 by means of the valve closing face 8 located outside the axial bore. The valve subassembly consequently acts, overall, in the same way as a closing body unit separating the first pressure region from the second pressure region. The valve closing body 7 delimits the reception recess 16 in which a spring space 18 is thus formed and in which the first closing spring 10 and the second closing spring 35 are arranged.

In the pressure limiting and suction valve unit 1 according to the invention, in contrast to the prior art, the valve pin 13 is no longer guided in an additional blind bore at the bottom of the axial bore. The longitudinal bore 53 of the valve pin 13 issues directly into the spring space 8 in the first housing part 2 and thus connects the first pressure region 5 to the spring space 18. In the pressure limiting and suction valve unit 1 according to the invention, the valve closing body 7 is partially also incorporated into the reception recess 16 and is guided there axially displaceably by means of a guidance diameter D. The valve closing body 7 is guided sealingly, with narrow play, in the reception recess 16, and, with the exception of unavoidable leakage streams, there is no fluidic connection between the second pressure region 6 and the spring space 18. Correspondingly, the valve pin 13 is guided sealingly, with narrow play, in the valve closing body 7 in a guide portion 19 having the diameter d₁, in order, here too, to avoid a fluid connection. Sealing rings may also be provided at the sealing points. However, this entails additional outlay and is detrimental to the dynamic behavior of the valve.

The valve closing body 7 has a region with a plurality of transverse bores 20 which intersect one another along the axis of symmetry in the region 27 and which penetrate through the valve closing body 7 between the first guide portion 19 and the second sealing seat. The region 27 and the transverse bores 20 therefore likewise belong to the second pressure region which consequently forms a volume separated from the spring space 18 via the guide portion 19. This volume is permanently at the same pressure level as the working line connection 6. The region 27 is connected, in turn, to the valve closing body orifice 11, so that, when the closing head 14 is lifted off, a connection is made between the feed connection 5 and the working line connection 6. As a result of the first closing spring 10 being compressed, the spring plate 15 and the valve pin 13 connected to it can be displaced in relation to the valve closing body 7 in the direction of the feed connection 5 and open the valve closing body orifice 11 by the closing head 14 of the valve pin 13 being lifted off from the second valve seat 12.

The functioning of the pressure limiting and suction valve unit according to the invention will be explained below by means of the exemplary embodiment, as shown in FIG. 1.

When a hydraulic plant, for example a travel drive, is in operation, basically two operating states may occur: when high pressure is present in the working line connected to the working line connection 6, the pressure prevailing there is higher than the pressure which prevails at the feed connection 5 and, as already described, may amount to 25 bar. In this case, pressure limitation in the second pressure region and therefore in the working line has to be ensured by means of the pressure limiting and suction valve unit 1 according to the invention. The exemplary embodiments are based on circular cross-sectional areas, and therefore the following explanations are given, using their diameters. The pressure-active area of the valve pin 13, said pressure-active area being acted upon by the pressure of the working line connection 6 in the opening direction of the pressure limiting valve, is in this case obtained from the difference between the diameter of the second valve seat 12 and the diameter d₁ of that part of the valve pin 13 which is guided in the guide portion 19. Since the diameter d₁ of the valve pin 13 in the guide portion 19 is smaller than the diameter of the second valve seat, the pressure of the second pressure region generates a hydraulic force which acts upon the valve pin 13 counter to the force of the first closing spring. The force of the second closing spring 35 acts codirectionally with this force. In addition to the force of the first closing spring 10, a hydraulic force acts codirectionally with this upon the valve pin 13 and is caused by the pressure of the first pressure region. This, too, acts upon a differential area which is obtained from the different diameters in the region of the guide portion 19 and of the second sealing seat 12. If, then, the hydraulic force difference at the valve pin 13 overshoots the force difference fixed by the two closing springs 10, 35, the closing head 14 lifts off from the second valve seat 12 and connects the first and the second pressure region. Pressure medium can thus flow out from the second pressure region into the first pressure region. A pressure-active area capable of being set is thus provided by adapting the different diameters in the region of the guide portion 19 and of the second valve seat 12. The selection of the diameter d₁, reduced with respect to the valve seat 12, of the guide portion 19 therefore makes it possible to carry out simple setting with regard to the pressures to be expected.

By contrast, if the working line connected to the working line connection 6 forms the low-pressure side of the hydraulic plant, for example in the case of a reversal of direction of travel or load reversal, the pressure prevailing there tends to become lower than the pressure prevailing in the first pressure region. In this case, the suction function of the pressure limiting and suction valve unit 1 plays a part. If the pressure in the working line falls below a stipulated value, it is necessary for pressure medium to be conveyed out of the feed system into the working line. In terms of the suction function, the entire valve subassembly is first held in bearing contact against the first sealing seat 9 by the second closing spring 35. The guidance diameter D of the valve closing body 7 is smaller than the diameter of the first valve seat 9. The pressure of the first pressure region therefore causes a hydraulic force counteracting the force of the second closing spring 35 to act upon the valve subassembly. By contrast, the then lower pressure of the second pressure region acts in the region 27, the transverse bores 20 and the working line connection 6. The pressure of the second pressure region 6 thus acts codirectionally with the force of the second closing spring 35 upon the valve subassembly. If, then, the pressure difference between the first pressure region and the second pressure region overshoots a value which is stipulated by the second closing spring 35 and may lie between 1 and 1.5 bar, the entire valve subassembly and therefore, in particular, the valve closing body 7 lift off from the first sealing seat 9 and release a throughflow connection between the first pressure region 5 and the second pressure region 6.

FIG. 2 shows an alternative exemplary embodiment of the pressure limiting and suction valve unit 1 according to the invention. In this case, the same reference symbols have been adopted for components having the same function.

In the pressure limiting and suction valve unit 1′ according to the second exemplary embodiment, the spring space 18 in the first valve housing part 2 is not implemented as a longitudinal bore, as in the pressure limiting and suction valve unit 1 of FIG. 1. Instead, the spring space 18 has a contraction of the diameter of the reception recess 16′ in each of the regions guiding the valve subassembly 7′, 10, 13′, 15. A first contraction 29 guides the spring plate 15 with play and a second contraction 30 guides sealingly that part of the closing body 7′ which is located in the reception recess 16′ and separates the spring space 18 from the second pressure region. Such a reception recess 16′ may be implemented, for example, by casting the first valve housing part 2 and by subsequent cutting machining. In this case, the second contraction 30 is radially somewhat wider than the first contraction 29, so that the valve subassembly 7′, 10, 13′, 15 can be introduced into the reception recess 16 in a simple way during production.

Furthermore, the working line connection 6 is connected to the valve closing body orifice 11 via the region 27 and via the transverse bores 20 which can be seen only partially on account of the position of the section in FIG. 2. A connecting duct 25 formed in the valve closing body 7′ connects the working line connection 6 to an annular groove 26 which is arranged in the valve closing body 7′ and surrounds the valve pin 13′ and which constitutes a volume connected to the second pressure region. In this region of the annular groove 26, a step 28 implements a step-shaped reduction in the diameter of the valve pin 13′ in the direction of the reception recess 16′. The resulting annular surface on the valve pin 13′ is acted upon with the pressure of the second pressure region on the working line connection 6, so that an opening hydraulic force is generated upon the valve pin 13′ by the pressure of the second pressure region. The guide portion 19 is formed on that side of the step 28 which faces the spring space 18. In addition to this first guide portion 19, a second guide portion 21 is formed in the valve closing body 7′ on the side facing the second pressure region and the closing head 14.

Both in the first and in the second exemplary embodiment of the pressure limiting and suction valve unit 1, 1′ according to the invention, the spring space 18 connected via the longitudinal bore 53 to the first pressure region and acting as a volume connected to the first pressure region is separated by the first guide portion 19 from a volume acted upon by the pressure of the working line or from the second pressure region. While, in the first exemplary embodiment, the first guide portion 19 separates the spring space 18 from the region 27, in the second exemplary embodiment according to FIG. 2 the annular groove 26 is provided, as a volume connected to the second pressure region, in the valve closing body 7′. Consequently, in the region of the second guide portion 21 which follows the step 28 in the direction of the closing head 14, a diameter d₂ of the second guide portion 21 and therefore of the valve piston 13′ can be selected such that it is equal to the diameter of the second sealing seat 12. No axial forces then act upon the valve piston 13′ in the region 27 on account of the pressure of the second pressure region. The hydraulic forces acting upon the valve piston 13′ in the opening direction of the pressure limiting valve on account of the pressure in the second pressure region take effect solely at the step 28 in order to generate a resultant force, whereas they otherwise cancel one another.

The spring plate 15 and the valve closing body 7′ have, in each case toward the first closing spring 10, shanks which surround the valve pin 13′ and are configured such that they can center the first closing spring 10 at its ends. This likewise makes it easier to produce the valve subassembly 7′, 10, 17, 13′, 15.

FIG. 3 shows a third, especially preferred exemplary embodiment. As in the exemplary embodiment of FIG. 2, here too, a first guide portion 19 and a second guide portion 21 are formed between the region 27 and the spring space 18 in the valve closing body 7″. The cross-sectional area or the diameter d₁ of the first guide portion 19 is in this case again smaller than the cross-sectional area or the diameter d₂ of the second guide portion 21. A volume is again formed in the valve body 7″ between the two guide portions 19 and 21 by an annular duct 26′. The valve pin 13″ is guided both in the first guide portion 19 and in the second guide portion 21 sealingly, but displaceably in the longitudinal direction. The step 28 is again formed on the valve pin 13″. The position of the step 28 and of a transverse bore 22 connected to the first pressure region is selected such that, both in the closed state of the pressure limiting valve and in the open state, there is a fluidic connection of the first pressure region to the volume upstream of the step 28 on account of the axial extent of the annular duct 26′. The annular surface formed by the step 28 is consequently acted upon in each case by the pressure prevailing in the first pressure region. Moreover, the annular duct 26′ affords an advantageous distance between the two guide portions 19 and 21. In addition to an improvement in guidance, an advantage also arises in terms of manufacture, since difficult machining directly at the jump in diameter between the two guide portions is avoided.

In contrast to the exemplary embodiment of FIG. 2, here the volume of the annular duct 26′ is not acted upon by the pressure of the second pressure region, but instead by the pressure of the first pressure region. Hence, in contrast to the version according to FIG. 2, the second guide portion 21 must also cooperate sealingly with the valve pin 13″. A shortened longitudinal bore 53′ is provided in the valve pin 13″. The shortened longitudinal bore 53′ issues into the transverse bore 22, so that the annular duct 26′ forms a volume connected to the first pressure region. The transverse bore 22 penetrates through the valve pin 13″ preferably along the diameter. This may take place either in the region of the first diameter d₁, which corresponds to the diameter of the first guide portion 19, or else, as is preferred and illustrated, in the region of the second diameter d₂, as illustrated in the drawing. The second diameter d₂ corresponds to the diameter of the second guide portion 21.

To open the pressure limiting valve, that is to say to lift off the closing head 14 from the second sealing seat 12, a hydraulic force must act upon the valve pin 13″ on account of the pressure difference between the first pressure region and the second pressure region, as already described with regard to the previous versions. In the exemplary embodiment illustrated, the spring space 18 is connected to the second pressure region at the working line connection 6 via a connecting duct 31. In the example illustrated, the connecting duct 31 is formed on the outer circumference of the valve closing body 7″ in the guide region of the latter. This serves, however, merely to illustrate the connection between the second pressure region and the spring space 18. The diameter D in the guide region of the valve closing body 7″ in the reception recess 16 is preferably selected in order to form a clearance fit. A “clearance fit” generally means that the outside diameter of the inserted component is smaller than the inside diameter of the receiving component. A gap is thereby generated between the valve closing body 7″ and the reception recess 16 and allows pressure equalization between the spring space 18 and the second pressure region.

Moreover, in the exemplary embodiment illustrated, the diameter of the second valve seat 12 is exactly as large as the diameter d₂ of the second guide portion 21. Consequently, only an end face 32 of the valve pin 13″, the size of which end face is given by the diameter d₁, is acted upon effectively by the pressure of the second pressure region. The end face 32 of the valve pin 13″, on its side facing away from the closing head 14, projects into the spring space 18 in all three exemplary embodiments, but is not guided in a blind bore separately provided in the first valve housing part 2. In all the exemplary embodiments, therefore, action of hydraulic force upon the end face 32 of the valve pin 13″ always takes place with the pressure prevailing in the spring space 18.

In contrast to the exemplary embodiment of FIG. 2, in which the volume of the annular duct 26 is acted upon by the high pressure of the working line in order to ensure the pressure limiting function and the spring space 18 is acted upon by the pressure of the feed system, in the exemplary embodiment of FIG. 3 now the pressure conditions are reversed. Accordingly, in order to open the pressure limiting valve, the end face 32 of the valve piston 13″ is acted upon in the spring space 18 by the high pressure. On account of the radial step 28 of the valve pin 13″ and its guidance in the first guide portion 19 and the second guide portion 21, the size of the end face 32, acted upon effectively by the pressure of the second pressure region, of the valve pin 13″ can be set independently of the diameter of the second sealing seat. The diameter of the second sealing seat 12 and the diameter d₂ of the second guide portion 21 are identical. The pressure which prevails in the second pressure region and acts in the axial direction upon the valve piston in the region 27 then does not result in any axial force on the valve piston 13″. The advantage of this is that the diameter d₂ of the second guide portion 21 and the diameter of the second valve seat 12 can be given different sizes in various valve variants without any effects upon the start of opening of the pressure limiting and suction valve unit 1″. In particular, the injection area when the pressure limiting valve is opened can consequently be adapted easily, without different closing springs 10 having to be used.

If, in addition to the hydraulic force acting on the end face 32, a further force is also to take effect as a result of the pressure of the second pressure region, the selected diameter of the second sealing seat may also be larger than the diameter d₂ of the second guide portion 21.

In all three exemplary embodiments shown, furthermore, the diameter of the spring plate 15 is selected such that the part volumes of the spring space 18 which are formed on both sides of the spring plate 15 are connected fluidically to one another via a gap on the outer circumference of the spring plate 15. In the exemplary embodiment illustrated in FIG. 2, the connecting duct 25 in the valve closing body 7′ is arranged obliquely with respect to the valve longitudinal axis and connects an outer circumference of the valve closing body 7′ to the annular duct 26. Likewise, however, a connecting duct extending in the axial direction may also be formed in the region of the second guide portion 21. On the other hand, in the exemplary embodiment according to FIG. 3, it is also possible to make the connection between the annular duct 26′ and the first pressure region by means of the valve closing body. The latter would then have to have, emanating from the annular duct 26′, at least one duct which runs throughbetween the transverse bores 20 toward the valve seat face 8. In the same way, the spring space 18 may also be connected to the first pressure region in the exemplary embodiment according to FIG. 2 via corresponding bores in the longitudinal direction of the valve closing body 7′.

The invention is not restricted to the exemplary embodiments illustrated. In particular, advantageous combinations of individual features of the various exemplary embodiments with one another are possible.

1. A pressure limiting and suction valve unit, comprising:
a valve closing body including a valve closing face, which, together with a first valve seat lying opposite the valve closing face, forms a first sealing seat for sealing off a first pressure region from a second pressure region;
a second valve seat defining a valve closing body orifice, the valve closing body orifice, together with a closing head formed on an axially movable valve pin, forms a second sealing seat for sealing off the second pressure region from the first pressure region;
a spring plate connected to the valve pin and movable axially together with the valve pin;
a first closing spring which is tension-mounted between the spring plate and the valve closing body and prestresses the valve pin against the second valve seat formed on the valve closing body; and
a second closing spring which prestresses a valve subassembly against the first valve seat,
wherein the valve pin is guided sealingly in at least one first guide portion formed in the valve closing body,
wherein the second valve seat and the first guide portion are configured to be arranged on different sides of the second pressure region with respect to the direction of movement of the valve pin,
wherein the first guide portion is configured to separate a volume connected to the first pressure region from one of the second pressure region and a volume connected to the second pressure region, and
wherein a cross-sectional area of the first guide portion is configured to define a surface of a valve pin, said surface being acted upon by the pressure of the second pressure region, is smaller than a cross-sectional area of the second valve seat.

2. The pressure limiting and suction valve unit as claimed in claim 1, wherein the valve pin has a radial step which is arranged in a volume formed in the valve closing body and is connected to one of the first pressure region and the second pressure region.

3. The pressure limiting and suction valve unit as claimed in claim 2, wherein in order to connect the first pressure region to the volume in the valve closing body, at least one connecting duct is formed in the valve closing body or in the valve pin.

4. The pressure limiting and suction valve unit as claimed in claim 2, wherein in order to connect the second pressure region to the volume in the valve closing body, at least one connecting duct is formed in the valve closing body.

5. The pressure limiting and suction valve unit as claimed in claim 2, wherein a spring space formed on that side of the valve closing body which faces away from the closing head is connected to the other pressure region in each case.

6. The pressure limiting and suction valve unit as claimed in claim 5, wherein that portion of the valve pin which has a smaller diameter penetrates through the valve closing body in a direction away from the closing head and projects into the spring space, so that an end face of the valve pin is acted upon by the pressure prevailing in the spring space.

7. The pressure limiting and suction valve unit as claimed in claim 2, wherein a second guide portion, in which the valve pin guided, is formed in the valve closing body on that side of the radial step of the valve pin which faces the closing head.

8. The pressure limiting and suction valve unit as claimed in claim 7, wherein the second guide portion and the second valve seat have the same diameter.

9. The pressure limiting and suction valve unit as claimed in claim 5, wherein, in order to form a fluidic connection between the spring space and the second pressure region, a clearance fit is formed on a guidance diameter of the valve closing body.

10. The pressure limiting and suction valve unit as claimed in claim 9, wherein the diameter of the first sealing seat and the guidance diameter of the valve closing body are of equal size.
